(19) United States
(12) Patent Application Publication
(10) Pub. No.: US 2014/0214341 A1
(43) Pub. Date: Jul. 31, 2014

(54) Electronic Valve Position Indicator

(71) Applicant: David Duane Rogers, JR., Quakertown, PA (US)

(72) Inventor: David Duane Rogers, JR., Quakertown, PA (US)

(21) Appl. No.: 14/239,405

(22) PCT Filed: Sep. 9, 2011
(86) PCT No.: PCT/US2011/051052

§ 371 Date: Feb. 18, 2014

(51) Int. Cl. G01L 11/00

(52) U.S. Cl. CPC G01L 11/00
USPC 702/50

(57) ABSTRACT

An apparatus includes a valve having at least two input ports. A first of the at least two input ports connected to a first source of material and a second of the at least two input ports connected to a second source of material. The also valve includes an output port and a valve selector for selectively connecting one of the at least two input ports to the output port. An electric circuit selectively connects an output device to receive data from a first sensor associated with the first source of material that senses at least one characteristic associated with the first source of material when the valve selector is in a first position connecting the first of the two input ports to the output port, and a second sensor associated with a second source of material that senses at least one characteristic associated with the second source of material when the valve selector is in a second position connecting the second of the two input ports to the output port.

### FIELD OF THE INVENTION

This invention concerns an apparatus and method for automatically selecting and identifying a characteristic associated with a material stored at a source in response to selection of that source.

### BACKGROUND OF THE INVENTION

Pressurized material may be stored in a tank or other vessel. Pressurized material may be a pressurized gas or a pressurized liquid. A common example is pressurized air which is stored in a tank and selectively controlled to be delivered to a person via a mask positioned over the mouth and nose of the person thereby enabling the person to breathe freely. One such example of when pressurized air tanks are used is in the healthcare environment to provide life support to patient in transit. For example, pressurized air tanks may be used to provide air to infants being transported in an incubator. In another example, it may be necessary to provide clean air in an environment that may otherwise be contaminated. Air tanks are also conventionally used by firefighters who enter smoke-filled buildings in search of victims trapped by fire. This is merely one example and any search and rescue personnel that enter environments that have insufficient oxygen levels that prevent a person from breathing and functioning in a normal manner may employ these types of apparatuses. In these scenarios, as there is a finite amount of pressurized air stored in a tank, these personnel typically carry multiple tanks (e.g. multiple sources of pressurized air) to provide them with extended time to accomplish the task required, i.e. searching for victims.

Switching between multiple pressure sources is conventionally performed using a valve such as the ones depicted in FIGS. 1A and 1B. FIG. 1A depicts a 5-port valve 1 that enables flow of the pressurized material (e.g., air, gas, or liquid) from an area of high pressure to an area of low pressure. Continuing with the example described above, the air in the tank is highly pressurized and flows from the tank to a destination (e.g. air mask) where the pressure level is lower than in the tank. The valve 1 in FIG. 1A includes a valve body 2 that includes a first set of ports 3. The first set of ports 3 include ports 3a and 3b. The body of the valve further includes two additional ports on opposing sides of ports 3a and 3b. Additionally, the valve body 2 may include a second port 4. An internal valve member (not shown) is positioned between the first set of ports 3 and the second port 4 for controlling the directional flow of the air. A collar 6 is positioned on a side of the body opposite the second port 4 forming a seal preventing any air flowing through the valve from escaping. A handle 7 is connected to the valve body 2 by a stem 5 which selectively transmits the motion of the handle 7 to the internal valve member. The position of the internal valve member determines the path along which the air will flow. In one configuration, multiple sources of pressurized air may be connected to respective ones of the first set of ports 3 resulting in the ports 3 being input ports. In this configuration, the position of the handle 7 corresponds to port 3a directing the air to flow from the pressure source connected to port 3a for passage through the body 2 and out of second port 4. When a first source of gas is depleted, the handle 7 may be selectively rotated to enable gas flow from a second pressure source connected to port 3b. The valve 1 shown in FIG. 1A governs the flow of gas from up to four pressure sources through the body 2 and out through second port 4. Similarly to FIG. 1A, valve 1b in FIG. 1B includes similar elements that operate in a similar manner. However, valve 1b is a 7-port valve. Thus, the only difference is that first set of ports 3 includes six ports thus allowing up to six pressure sources to be connected thereto.

These valves successfully enable multiple sources of pressurized gas, air or liquid to be connected to and distributed through an output. A drawback associated with these valves is that a user is unaware of how much pressurized material is remaining in any of the pressure sources connected to the valve. Thus, a need exists to automatically notify a user as to an amount of pressurized material present in a pressure source upon selection of the pressure source. An apparatus according to invention principles addresses deficiencies of known pressure control apparatus.

### SUMMARY OF THE INVENTION

In one embodiment, an apparatus is provided and includes a valve having at least two input ports. A first of the at least two input ports connected to a first source of material and a second of the at least two input ports connected to a second source of material. The valve also includes an output port and a valve selector for selectively connecting one of the at least two input ports to the output port. An electric circuit selectively connects an output device to receive data from a first sensor associated with the first source of material that senses at least one characteristic associated with the first source of material when the valve selector is in a first position connecting the first of the two input ports to the output port, and a second sensor associated with a second source of material that senses at least one characteristic associated with the second source of material when the valve selector is in a second position connecting the second of the two input ports to the output port.

In another embodiment, a method of selecting a source of material from at least two sources of material and providing data associated with the selected source is provided. The method includes selecting a respective one of a plurality of sources connected to a valve using a source selection apparatus having an actuator positioned thereon, each source including a sensor that senses data representing at least one characteristic associated with the respective source and generates a data signal. A switch associated with the selected source is actuated causing the switch to move from a first open position to a second closed position. The data signal is provided to an output device via the switch and a material within the selected source is provided to a destination through a valve.

### BRIEF DESCRIPTION OF THE DRAWINGS

FIGS. 1A and 1B are exemplary prior art valves for controlling a flow of pressurized material;

FIG. 2 is a top view of an exemplary circuit board of the electronic valve position indicator according to invention principles;

FIG. 3 is a side view taken along line 3-3 in FIG. 2 of an exemplary circuit board of the electronic valve position indicator according to invention principles;

FIG. 4 is an exemplary circuit diagram of the electronic valve position indicator according to invention principles;

FIG. 5 is an exemplary circuit diagram of the electronic valve position indicator according to invention principles;

FIG. 6 is an exemplary wire diagram of the electronic valve position indicator according to invention principles;

FIG. 7 is an exemplary circuit diagram of an alternate embodiment of the electronic valve position indicator according to invention principles;

FIGS. 8A-8D are exemplary circuit board patterns for the electronic valve position indicator according to invention principles;

FIG. 9 is a side view of the electronic valve position indicator coupled with a valve according to invention principles;

FIG. 10 is a flow diagram detailing the operation of the electronic valve position indicator according to invention principles;

FIG. 11 is an exemplary circuit diagram of the electronic valve position indicator according to invention principles; and

FIG. 12 is an exemplary circuit diagram of the electronic valve position indicator according to invention principles

### DETAILED DESCRIPTION

A pressurized material as used herein may include a gas, air or liquid. The pressurized material may be stored in a source such as a tank or vessel. The flow of pressurized material from the pressure source through an output is controlled by a valve. The valve may select a respective source from a set of sources and control the flow path of the pressurized material from the source to an output. Alternatively, there may be a single source connected to the valve and the valve may select a respective output from a plurality of outputs through which the pressurized material will flow. In the instance where multiple pressure sources are controlled by a single valve it is advantageous to automatically be informed of an amount of pressure remaining in a respective source of pressurized material from which the pressurized material originates. An electronic valve position indicator advantageously automatically receives and notifies a user of a pressure of the pressurized material remaining in the source in response to selection of the source. The electronic valve position indicator automatically receives a signal representing an amount of pressure remaining in the source from a pressure sensor coupled to the source. Upon movement of a valve selection mechanism to select a source from a plurality of sources as an input, a pressure sensor connected to the selected source transmits a signal representing the pressure sensed within the selected source to an output device such as a display screen. This advantageously enables a user to view the pressure of the material remaining within the selected source. When a different source is selected as the input, data representing an amount of pressure within that source is provided to the output device. Thus, the electronic valve position indicator automatically enables a user to immediately know a pressure of the pressurized material that remains in a respective source.

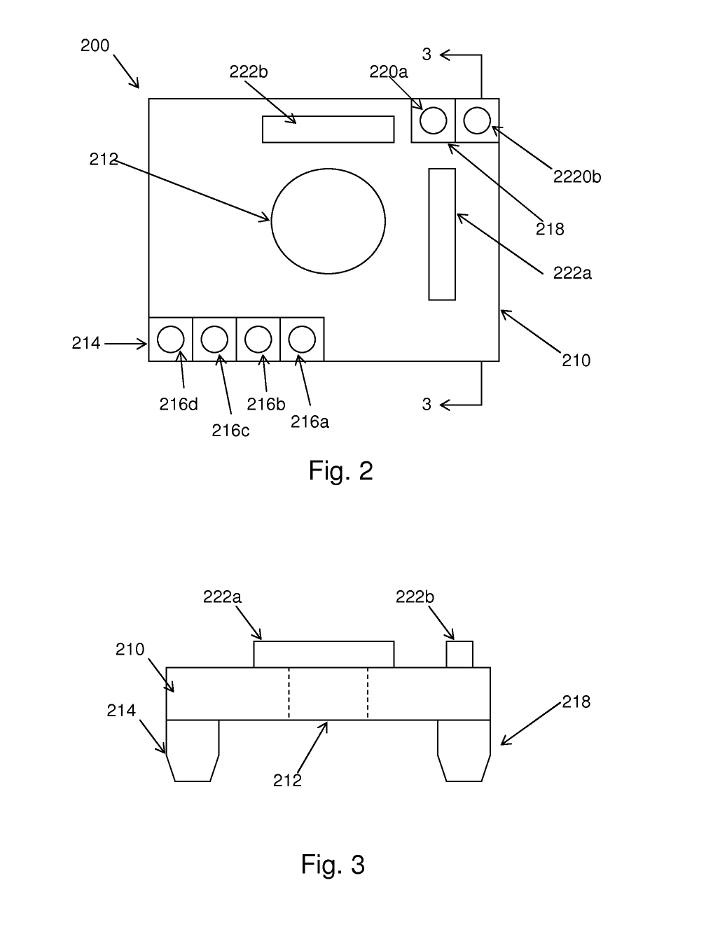

FIG. 2 is an exemplary circuit board 210 identifying components forming the electronic valve position indicator 200. The circuit board 210 may be a conventional printed circuit board that is non-conductive and which includes etched conductive pathways enabling electrical connection between the components mounted thereon. The circuit board 210 may include an aperture 212 at substantially a central point thereof. The aperture 212 receives a stem of a valve connected to the sources of pressurized material therethrough. While the circuit board 210 is described as having a single aperture 212, it should be understood that the circuit board 210 may include any number of apertures 212. The number of apertures 212 may correspond to the number of valves in an array of valves.

The circuit board 210 also includes input terminal blocks 214. The input jumpers 214 enable electrical connection between the circuit board 210 and a plurality of sensors associated with a plurality of sources. As shown herein, the input terminal blocks 214 include a first input terminal 216a enabling electrical connection with a first pressure sensor and a second input terminal 216b enabling electrical connection with a second different pressure sensor. This embodiment describes four inputs 216a-216d. However, the circuit board 210 may be formed with any number of input terminals corresponding to an equal number of sources controllable by a particular valve.

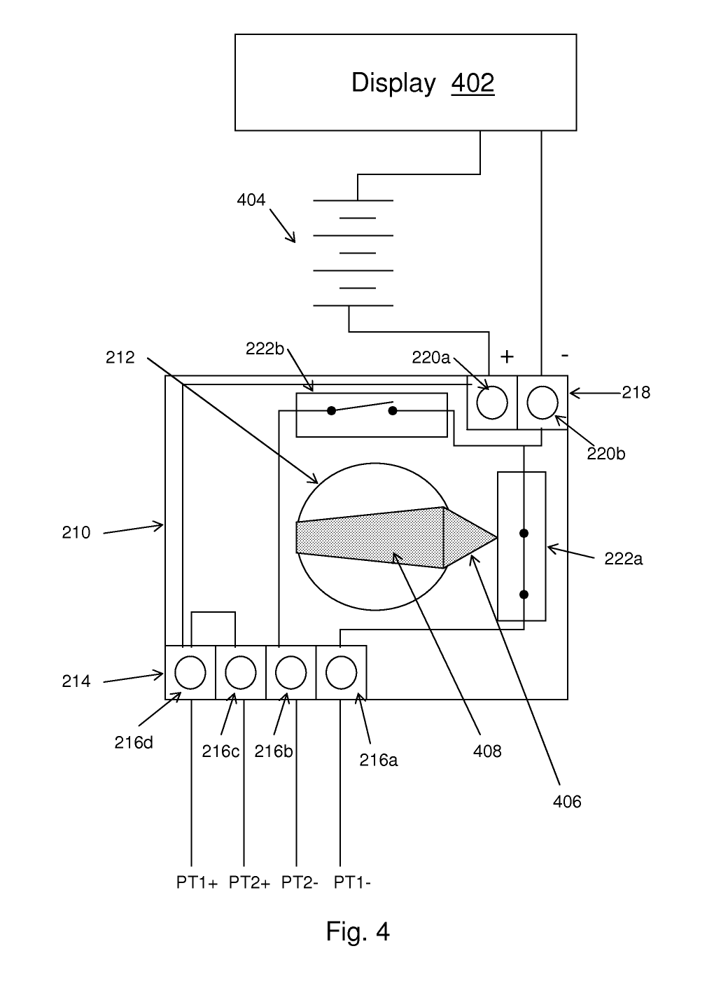

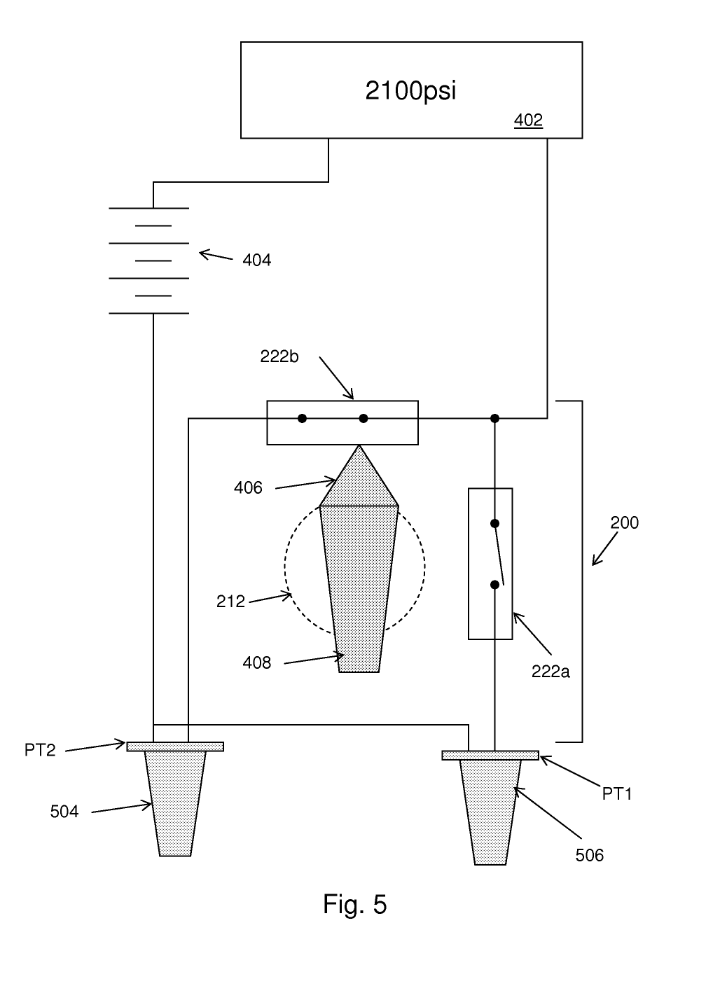

The circuit board 210 includes a plurality of selectively actuatable switches 222 corresponding to a number of pressure sources connected to the valve. In one embodiment, a first switch 222a corresponding to a first pressure source (not shown) and a second switch 222b corresponding to a second different source (not shown) is provided. While only two switches 222a and 222b are shown, one skilled in the art will appreciate that the circuit board 210 may include any number of switches corresponding to any number of sources controllable by a particular valve. The position of the switches 222 on the circuit board 210 should each be substantially aligned with a respective port on the body of the valve. Operation of the switches will be discussed hereinafter with respect to FIGS. 4 and 5.

A set of output terminal blocks 218 are provided enabling electrical connection with at least one output device. An output device may include at least one of (a) a display screen; (b) a wearable display device; (c) a gauge; (d) a computerized monitoring system; (e) a database; and (f) a communication device that transmits a signal over a wired or wireless communication network. The output terminal blocks 218 may include a first output terminal 220a and a second output terminal 220b. Electrical connections between the input terminal blocks 214, switches 222 and output terminal blocks 218 will be discussed hereinafter with respect to FIG. 4.

FIG. 3 is a side view of the circuit board 210 taken along the line 3-3 in FIG. 2. The circuit board 210 includes the aperture 212 extending therethrough. The boundaries of the aperture 212 are shown as dashed lines. The input terminal blocks 214 are located along a first edge of the circuit board 210 and the output terminal blocks 218 are located along a second edge of the circuit board 210 opposite the edge on which the input terminal blocks 214 are located. A plurality of sensors corresponding to a plurality of sources of pressurized material are each connected to the a respective one of the input terminal blocks 214. The at least one output device is connected to the output terminal blocks 218. The configuration of the input and output terminal blocks 214 and 218 are shown and described for purposes of example only and in practice may be in may be in any position on the circuit board 210. As shown herein, the first switch 222a is perpendicular to the second switch 222b. These positions are merely exemplary and correspond to the position of ports on the body of the valve. Upon moving a valve selection mechanism (e.g. handle) of the valve to select a port, an actuator on the valve selection mechanism selectively actuates a switch on the circuit board corresponding to the selected port. This enables data sensed by a sensor associated with a selected source connected to the selected port to be provided for output on the at least one output device.

The embodiment described in FIGS. 2 and 3 represent an electronic valve position indicator for a 3 port valve whereby there are two input ports connecting two sources of pressurized material to a common output port. The electrical connection and operation of the electronic valve position indicator 200 will be further discussed with respect to FIGS. 4 and 5. Any depiction in of a “+” or “−” are for identification purposes to differentiate different terminals and do not necessarily reflect the polarity of a signal being transmitted unless stated.

The circuit board 210 in FIG. 4 receives a stem of a valve through aperture 212. The valve selectively controls the flow of pressurized material from a first source having a first pressure transducer (PT1) and a second source having a second pressure transducer (PT2). PT1 and PT2 are each coupled to the circuit board 210 by a positive lead and a negative lead. The negative lead PT1− is connected to an input of the first switch 222a on the circuit board 210 via input 216a. The negative lead PT2− is connected to an input of the second switch 222b on the circuit board 210 via input 216b. Both the first switch 222a and the second switch 222b are connected to an output port 220b. The positive leads PT2+ and PT1+ are connected to the circuit board 210 at input leads 216c and 216d, respectively. Inputs 216c and 216d are connected together and to an output port 220a. As described herein with respect to FIG. 4 which represents a 4-20 mA loop powered circuit, the depictions of positive and negative polarity are accurate. However, this may not be the case in other embodiments. Unless otherwise stated, any depiction of positive and negative is used as a differentiation of transmission paths and not necessarily the polarity of the signals.

The electronic valve position indicator 200 advantageously automatically outputs pressure data sensed by the pressure transducers PT1 and PT2 on an output display device 402 when a valve selection mechanism of a valve is turned to select a valve port to actuate either switch 222a or 222b and thus complete a circuit. The sensed pressure data represents a pressure of pressurized material remaining in the source at a given time. The display device 402 is connected to the circuit board 210 via an output terminal 220b. A DC power source 404 is coupled between an output terminal 220a and the display device 402. The output terminal 220a is further connected to the input terminal 216c and 216d and provides power to pressure transducers PT1 and PT2 via input terminals 216c and 216d.

The first switch 222a and second switch 222b are maintained in a first open position. When the switch 222a/222b is in the first open position the circuit is incomplete. Upon movement of a valve selection mechanism 408 of the valve, an actuator 406 is caused to actuate a selected one of the switches 222a/222b causing it to move from a first open position to a second closed position thereby completing a respective circuit. In one embodiment, the switches 222a and 222b may be magnetic reed switches and the actuator 406 may be a magnet. In this embodiment, the switches 222a/222b will move from the first open position to the second closed position in response to the positioning of the magnetic actuator 406 over a respective one of the switches. The description of magnetic reed switches is for purposes of example only and any switch that can sense the position of the valve selection mechanism may be employed. For example, the switch mechanism may include at least one of (a) an optical sensor and the actuator may be an LED light; (b) a proximity switch that senses the position of a valve handle; and (c) and RFID tag and sensor. Only one switch 222a or 222b may be in the second closed position at a time thereby ensuring that the data being transmitted across the completed circuit is accurate and only corresponds to the pressure data for a single selected source. The actuator 406 may be mounted on or formed within the valve selection mechanism 408 of the valve such that, in response to a user rotating the valve selection mechanism 408 of the valve to select a different source, the previously selected switch 222a or 222b will move from the second closed position to the first open position thereby breaking the circuit and enabling a newly selected one of the switches 222a or 222b to move from the first open position to the second closed position thereby completing a circuit an enabling monitoring of an amount of pressure within in the selected pressure source. Actuation of switches 222a or 222b may occur by positioning the actuator at least one of over the switch or adjacent the switch 222 such that the actuator is a certain distance from the switch.

Operation of the electronic valve position indicator will now be described with respect to the selection of the first source to which PT1 is connected for monitoring an amount of pressure therein. As discussed above, when the first source is selected, an actuator 406 connected on the valve selection mechanism 408 is positioned adjacent the first switch 222a causing the first switch 222a to move from the first open position to the second closed position thereby completing a circuit. Direct current from the DC source 404 flows through output terminal 220a and through the circuit board 210 and further through input terminal 216c to provide power to PT1. PT1 may automatically and continuously sense an amount of pressure within the selected first source. At predefined intervals, a data signal including an amount of pressure within the selected source is provided at the input terminal 216a, across the first switch 222a and output to the display 402 via the output terminal 220b. A user may selectively view the amount of pressurize material remaining in the selected source and the pressure within the selected source. A user is thus able to determine if and when to select a different source.

FIG. 5 is an exemplary circuit diagram showing operation of the electronic valve position indicator 200 when the user changes the selected source from the first source 502 to the second source 504. For purposes of simplicity, certain elements of the electronic valve position indicator 200 are not shown. However, one skilled in the art will appreciate that the structure and connections described above with respect to FIG. 4 are applicable to FIG. 5 whereby similar elements are connected and operate in a similar manner.

When the valve selection mechanism 408 including the actuator 406 connected thereto is rotated into a position that enables flow of pressurized material from a source connected to a different port of the valve, the switch associated with the desired valve port is actuated. In this example, the valve selection mechanism 408 is a handle and will be referred to as such hereinafter. The handle 408 is rotated ninety degrees counterclockwise from the position shown in FIG. 4. Rotation of the handle 408 results in the actuator 406 being positioned adjacent the second switch 222b. The ninety degree rotation of handle 408 is described for purposes of example only and is applicable to the exemplary embodiment described herein that refers to a four position, five port valve. One skilled in the art would appreciate that the degree of rotation required to select a different source of material depends upon the number of ports on the valve whereby each port has a respective switch associated therewith. Upon rotation of the handle 408, a magnetic force from actuator 406 applied to the first switch 222a causing the first switch 222a to be in the second closed position is reduced and the first switch 222a returns to the first open position. The actuator 406 may exert a magnetic force on the second switch 222b causing the switch to move from the first open position into the second closed position thereby completing a circuit connecting the second pressure transducer PT2 to the output device 402 through the second switch 222b on the electronic valve position indicator 200. When the second switch 222b is in the second closed position, current flows from the power source 404 to the pressure transducer PT2 providing power to the pressure transducer PT2. Pressure transducer PT2 is thus able to monitor an amount of pressure within the second source 504. A data signal indicating the pressure within the second source 504 is provided through the second switch 222b for output on the output device 402. While the second source is selected, a user is advantageously able to automatically view a pressure of pressurized material remaining to determine if and when to select a different source. The data signal described herein referring to a pressure of a pressure source being sensed by a pressure transducer is described for purposes of example only. It should be noted that one skilled in the art may substitute any sensor capable of sensing any physical property to provide a data signal that indicates a value of the sensed physical property. Examples of physical properties able to be sensed include, but are not limited to, at least one of (a) temperature; (b) flow rate; (c) density; (e) viscosity; (f) PH; (g) conductance; (h) humidity; (i) remaining volume and (k) any other measurable physical attribute. In another embodiment, at least one additional sensor able to sense any measurable physical attribute may be provided in addition to the pressure transducer for sensing and providing a data signal including data representing the measured physical attribute. In this embodiment, the at least one additional sensor may be formed as its own circuit having its own switch that is actuated by the actuator. Alternatively, a multiplexer may be provided for receiving input data from multiple sensors to produce a single output data signal provided for display.

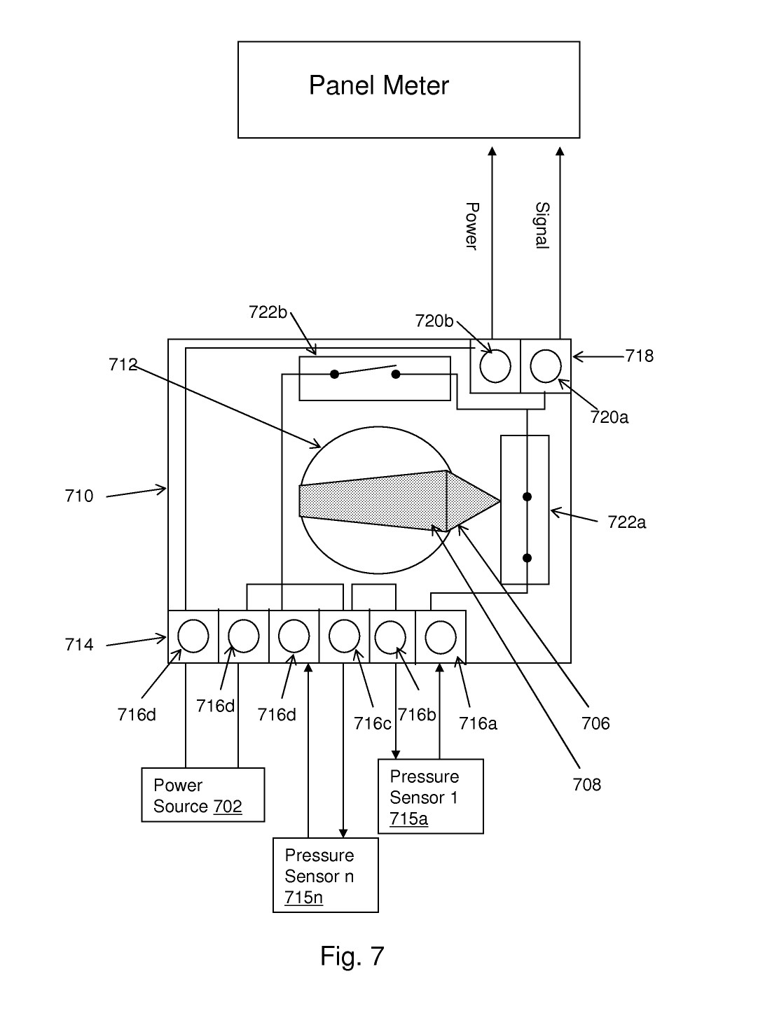

The data signal transmitted from the respective pressure transducers PT1 and PT2 may be a 4-20 milliamp signal that can be output on a display device. Alternatively, the data signal may be a 0-10 volt, 0-5 volt, or any other industry standard signal that can be output on a display device. The type of data signal depends on the type of sensor used to sense an amount of pressure within the pressure source. Additionally, the data signal could be digital rather than analog, as discussed hereinbelow with respect to FIG. 7. Additionally, the output of the data signal on a display 402 is described for purposes of example only and the data signal may be received by a computer processing system that may utilize the data signal as at least one input signal for a particular purpose. For example, the data signal may be received by a processing device to determine if a pressure level is below a threshold value and, upon receiving a data signal indicating that the pressure level is below the threshold value, the processing device may initiate a further action. For example, an alarm may be issued to suggest to the user or another party that the input source should be changed. Alternatively, the data signal may be stored in a database that stores historical pressure data thereby enabling a user to determine a rate at which pressure in a source is depleted. This may advantageously enable review of consumption rate of the pressurized material in a particular setting under a particular set of circumstances.

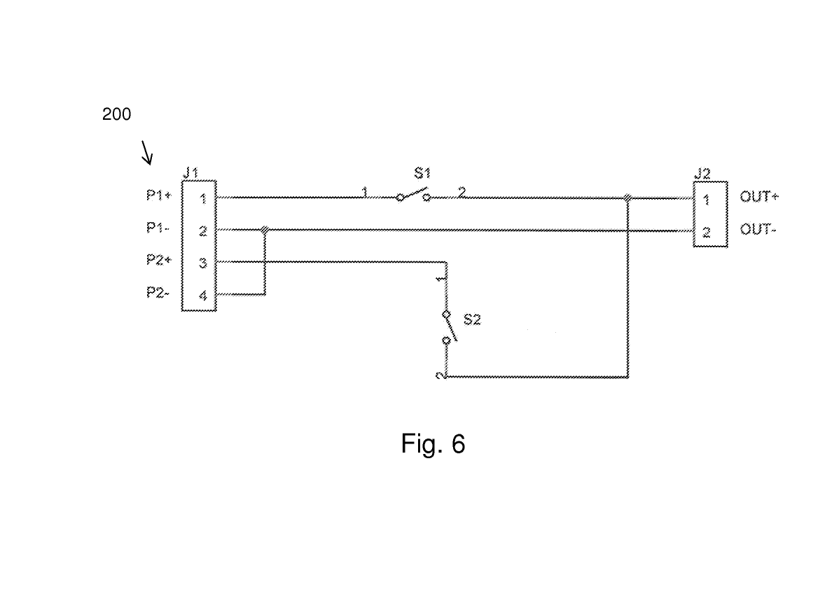

FIG. 6 is a circuit diagram of an alternate embodiment of the electronic valve position indicator 200. A first input terminal block J1 includes first terminals 1-4 for connection to respective sensors P1 and P2 that are associated with respective sources of material. Sensors P1 and P2 selectively monitor at least one characteristic associated with a material stored at its respective source. A second output terminal block J2 includes second terminal 1 and second terminal 2. A data input line originating from sensor P1 that monitors at least one characteristic associated with a material stored in a first source is connected to first terminal 1. A data input originating from a sensor P2 that monitors at least one characteristic associated with a material stored in a second source is connected to first terminal 3. First terminals 1 and 3 are each connected to a common output at second terminal 1 via a respective switch S1 or S2 such that a data signal sensed by a sensor P1 associated with the first source or a sensor P2 associated with the second source may be provided at the second terminal 1 for output thereof. Respective sensors associated with respective sources may sense at least one characteristic associated with the material stored at the respective source. The at least one characteristic may include at least one of (a) an amount of pressure (e.g, measured in psi) remaining in the source; (b) a volume level of a liquid at the source; (c) an indicator describing a type of material located at the respective source; (d) a rate at which the material is flowing from the source; (e) an amount of time remaining until the material is depleted from the respective source; (f) PH; (g) Flow; (h) density; (i) temperature; (j) conductance; (k) humidity; and (l) a gas specific sensor (e.g a CO sensor that senses a level of carbon monoxide in Air or Oxygen).

Sensors P1 and P2 are further connected to the electronic valve position indicator 200 at first input terminal 2 and first input terminal 4, respectively. First terminals 2 and 4 are connected to second output terminal 2. A power source is connected to the second output terminal 2 for providing power to sensors P1 and P2 via their respective connection at first input terminals 2 and 4, respectively.

A first switch S1 is provided between the first input terminal 1 and the second output terminal 1. The switch S1 is a selectively actuatable switch which is maintained in a first open position. The switch S1 is actuated in response to user selection of the first source. User selection of a first source results in material stored at the first source to be provided as input to a port of the valve to which the first source is connected, therethrough and output at an output port of the valve. Actuation of the first switch S1 may occur by selectively positioning an actuator adjacent thereto. In response to actuation of the first switch S1, a circuit comprising the sensor P1 associated with the selected source, the first switch S1, an output device connected at the second output terminal 1 and the power source connected at the second terminal 2 is completed. The sensor P1 is powered by the power source to monitor the at least one characteristic associated with the material within the first source and generate a data signal indicative of characteristic data. The data signal is transmitted to the output device connected at the second output terminal 1. Should the user desire to change the source, the actuator is selectively moved from a position adjacent the first switch S1 to a position adjacent the second switch S2. In response to repositioning of the actuator, the first switch S1 is caused to move from the second closed position to the first open position and the second switch S2 is caused to move from the first open position to the second closed position. When switch S2 is in the second closed position, a circuit comprising the sensor P2 associated with the newly selected source, the second switch S2, an output device connected at the second output terminal 1 and the power source connected at the second terminal 2 is completed. The sensor P2 is powered by the power source to monitor the at least one characteristic associated with the material at the second source and generate a data signal indicative of the characteristic data. The data signal is transmitted to the output device connected at the second output terminal 1. While this embodiment describes two switches S1 and S2 that are associated with sensor P1 and sensor P2, respectively, it should be noted that the electronic valve position indicator may employ any number of switches corresponding to any number of sources and sensors that may be accessed by a particular valve. For example, if the valve is a five port valve, there may be up to four sources that are connected to a common output port. In this embodiment, the electronic valve position indicator may include four selectively actuatable switches that connect sensors associated with each of the four sources to an output on the second output terminal block J2. Each switch should be disposed on a circuit board such that the respective switch is substantially aligned with a position that a valve handle is in when the particular port on the valve is selected open.

FIG. 7 is a circuit diagram of an alternate embodiment of the electronic valve position indictor according to invention principles. This embodiment includes similar elements described above with respect to FIGS. 3-5. However, the difference between the embodiment depicted in FIG. 7 as compared to those depicted and described above with respect to FIGS. 3-5 is the placement of the power source. FIGS. 3-5 represent a circuit with a looped power source such that the power source is contained within the circuit. In contrast, FIG. 7 represents a circuit with a non-looped power source 702. The power source 702 is coupled to a pair of input terminals 716e and 716f for providing power to a plurality of sensors that each sense at least one characteristic associated with a respective source of material and to an output device 402 that outputs data sensed by one of the plurality of sensors. In this embodiment, the output device is a panel meter able to selectively display at least one of an analog or digital data signal generated by one of the plurality of sensors. The power source 702 is connected to an input terminal 716e in the first terminal block 714. The input terminal 716e is further electrically connected to an output terminal 720b of a second terminal block 718. Power is provided from the power source 702 to the output device 402 through input terminal 716e and output terminal 720b. The power source 702 is further connected to the plurality of sensors 715a-715n for providing power thereto. The power source 702 is electrically coupled to input terminal 716f. Input terminal 716f is also connected to input terminal 716b and input terminal 716c for providing power to sensors connected thereto. The power source 702 being connected to two terminals is shown for purposes of example only and the power source may be connected to each terminal to which a respective sensor is connected. Alternatively, each sensor may include its own power source for providing power thereto.

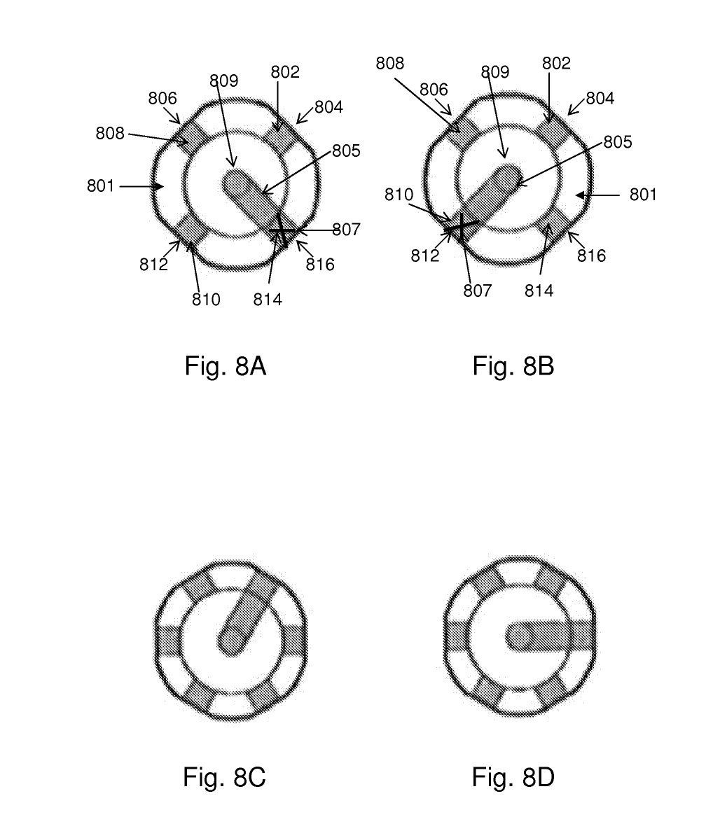

Circuit board 710 including an aperture 712 extending therethrough may be selectively receive a stem of a valve (see FIG. 8). The circuit board 710 includes the first input terminal block 714 that includes a plurality of individual input terminals 716a-716f. A plurality of sensors 715a-715n for sensing at least one characteristic from a respective source of material are connected to respective ones of the plurality of input terminals 716a-716d.

In one embodiment, a first sensor 715a is electrically coupled to input terminals 716a and 716b. The connection between the first sensor 715a and the first input terminal 716a is a data connection enabling transmission of a data signal representing data monitored by the first sensor 715a for display on an output device 402. The first sensor 715a is also connected to the circuit board 710 via the second input terminal 716b. Connection to terminal 716b connects the first sensor 715a to receive power from the power source 702. A first actuatable switch 722a is positioned between the input terminal 716a and the output terminal 720a. The first switch 722a moves between a first open position and a second closed position. When the switch 722a is in the first open position, no data transmission occurs as the circuit is incomplete. When an actuator 706 is positioned adjacent the first switch 722a, the switch 722a moves into a second closed position thereby completing the circuit and allowing a data signal representing data sensed by the first sensor 715a to be transmitted for output on the output device 402.

At least one additional sensor 715n is electrically coupled to the circuit board 710. This sensor is shown connected to input terminals 716c and 716d. The connection between the at least one additional sensor 715n and the third input terminal 716d is a data connection enabling transmission of a data signal representing data monitored by the at least one additional sensor 715n for display on an output device 402. The at least one additional sensor 715n is also connected to the circuit board 710 via the fourth input terminal 716c. Connection to terminal 716c connects the at least one additional sensor 715n to receive power from the power source 702. A second actuatable switch 722b is positioned between the input terminal 716d and the output terminal 720a. The second switch 722b moves between a first open position and a second closed position. When the switch 722b is in the first open position, no data transmission occurs as the circuit is incomplete. When the actuator 706 is moved adjacent the second switch 722b, the second switch 722b moves into a second closed position thereby completing the circuit. Additionally, the first switch 722a moves from the second closed position to the first open position when the actuator 706 is adjacent the second switch 722b. The completed circuit formed by closing the second switch 722b enables a data signal representing data sensed by the first sensor 715a to be transmitted for output on the output device 402.

The data displayed on the output device 402 corresponds to the data signal generated by the sensor coupled to the switch that is currently in the second closed position. Each sensor is powered by the power source 702 to automatically sense a characteristic associated with a material at its respective source. In one embodiment, the material is a pressurized gas being distributed from a gas source (e.g. a tank) connected to one input port on a multi-port valve. The respective input port on the valve is selected using a valve control mechanism (e.g. a handle) to form a pathway between the gas source and a destination by enabling the flow of gas through the input port to which the gas source is connected, valve and out an output port on the valve. In response to selecting an input port, the actuator on the valve control mechanism is positioned adjacent the switch associated with the selected valve input port and associated source thereby completing a circuit connecting a respective sensor to the output device 402. A sensor (e.g. a pressure transducer) is coupled to the gas source and may sense an amount of pressure within the gas source. The sensor may automatically and continually sense pressure levels at predefined intervals and generate a data signal including an amount of pressure at each interval. The data signal including an amount of pressure at a given time is transmitted for output on the output device 402.

When a user desires to select a different gas source connected to a different input port on the valve, the valve control mechanism is moved into a position closing the first pathway and forming a second pathway enabling gas flow from the second gas source to the destination through the valve. By moving the valve control mechanism, an actuator positioned thereon (or formed integral therein) is positioned adjacent a second switch associated with the selected valve input port thereby completing a circuit connecting the second sensor to the output device. The sensor (e.g. a pressure transducer) coupled to the second (and currently selected) gas source may sense an amount of pressure within the second gas source. The sensor may automatically and continually sense pressure levels at predefined intervals and generate a data signal including an amount of pressure at each interval. The data signal including an amount of pressure at a given time is transmitted for output on the output device 402.

This operation is described for purposes of example only and it should be appreciated that the electronic valve position indicator may operate with a valve with any number of input ports connected to a common output port. The electronic valve position indicator requires a number of switches equal to the number of selectable ports on the valve such that the switches are arranged on the circuit board in a pattern that allows for the valve control mechanism including an actuator to be positioned adjacent a respective switch corresponding to a respective input port on the valve. The actuator may be positioned adjacent to a respective one of the plurality of switches thereby completing a single circuit per position connecting a respective sensor to the output device. Thus, the position of the valve control mechanism opens a pathway way enabling flow of a material from a selected source through the valve and out to a destination as well as providing data representing at least one characteristic associated with the material flowing therethrough to the output device.

In another embodiment, a single source of material may be distributed through multiple output ports. This embodiment may utilize the same valve and circuitry described above with respect to FIGS. 2-7. In this embodiment, a single source of material is connected to an input port for distribution through one of a plurality of output ports. A sensor associated with the single source of material may sense at least one characteristic associated with the material at the single source and provide a data signal indicative of the at least one characteristic to an output device. In this embodiment, the valve position mechanism allows a user to selectively select a respective one of a plurality of output through which the material from the single source will flow. An example of this may include when a single tank of oxygen is used to supply a plurality of different users. As a respective one of the output ports is selected, a sensor may sense the amount of oxygen in tank and a user can use this information to determine when and if a different output should be selected.

Examples of switch placement configurations are shown in FIGS. 8A-8D. FIGS. 8A and 8B represent a five port valve including four input ports 804, 808, 812 and 816. The fifth port is an output port (not shown) to which each of the input ports 804, 808, 812 and 816 are selectively connected in response to manipulation of a valve selection mechanism 805 to align with a respective one of the input ports 804, 808, 812 and 816. As shown in FIG. 8A, the valve selection mechanism 805 is aligned with the fourth input port 816 enabling a flow of material from the fourth input source to a destination through the port 810 of the valve. A circuit board 801 includes a plurality of switches 802, 806, 810 and 814. Each switch is positioned on the circuit board 801 in substantial alignment with a respective input port 804, 808, 812 and 816. The first switch 802 is aligned with the first input port 804. The second switch 806 is aligned with the second input port 808. The third switch 810 is aligned with the third input port 812 and the fourth switch 814 is aligned with the fourth input port 816. The position of the switches is described as being in alignment with the input ports for purposes of example only and they may be in any arrangement that allows the position of the valve selection mechanism to select a respective input valve and actuate a switch associated with the selected input valve. The valve selection mechanism 805 includes an actuator 807 that, when positioned substantially adjacent a respective one of the switches 802, 806, 810 or 814, actuates the switch and completes the electrical circuit connecting a sensor to the output device as described above. In FIG. 8A, the actuator 807 on the valve selection mechanism 805 is positioned substantially adjacent to the fourth switch 814. Thus, the flow of material flows from the source connected thereto through the fourth input port 816 and out through the output port. Moreover, a sensor associated with the source connected to the fourth input port 816 will sense at least one characteristic associated with the source and provide that data for display on an output display device as described above. FIG. 8B includes the same configuration and elements as described in FIG. 8A. However, the valve selection mechanism 805 has been rotated 90 degrees clockwise causing the selected input port to be the third input port 812. The actuator 807 is positioned substantially adjacent to the third switch 810 and a sensor associated with the source connected to the third input port 812 will sense at least one characteristic associated with the source and provide that data for display on an output display device as described above. In this configuration, the valve selection mechanism 805 may be rotatable 360 degrees about a midpoint 809 of the circuit board 810 allowing free selection of the desired input port. FIGS. 8C and 8D represent a seven port valve including six input ports selectively connectable to an output port. The configurations and operation of the valve shown herein is similar to those described with respect to FIGS. 8A and 8B except there are two additional input ports and two additional switches that correspond to the two additional input ports. The additional switches corresponding to the additional input ports do not alter the operation of the electronic valve position indicator according to invention principles beyond providing the ability to select from additional sources.

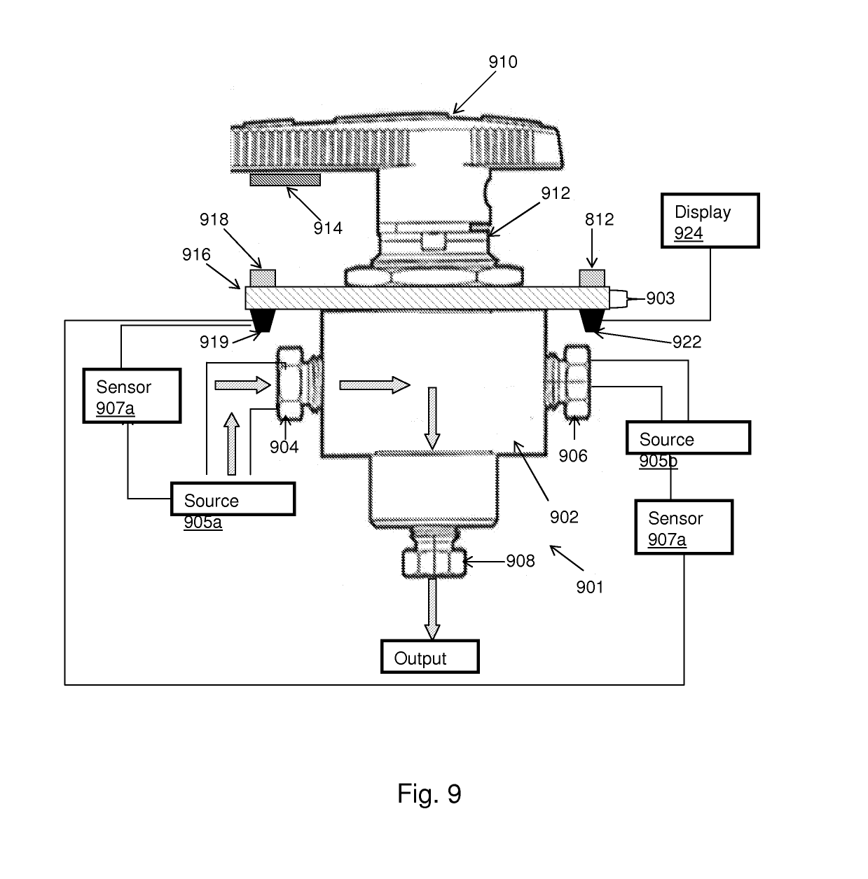

FIG. 9 is a side view of a valve 901 including the electronic valve position indicator 903. The valve 901 includes a valve body 902 having a first input port 904, a second input port 906 and an output port 908. A valve selection mechanism 910 having an actuator 914 is connected to the body 902 via stem 912 that enables selection of a respective source of pressurized material 905a, 905b coupled to the input ports 904, 906. The electronic valve position indicator 903 is mounted on the valve 901 and positioned between the valve selection mechanism 910 and the body 902. The electronic valve position indicator 903 includes a first switch 918 associated with the first input port 904 and a second switch 920 associated with the second input port 906. A first sensor 907a is connected between the first source 905a and an input terminal 919 of the electronic valve position indicator 903. The first sensor 907a senses data representing at least one characteristic associated with the source 905a. A second sensor 907b is connected between the second source 905b and the input terminal 919 of the electronic valve position indicator 903. The second sensor 907b senses data representing at least one characteristic associated with the second source 905b. An output device 924 for selectively outputting data sensed by sensors 907a, 907b is connected to an output terminal 922. The first switch 918 is connected between the first sensor 907a and the output device 924. The second switch 920 is connected between the second sensor 907b and the output device 924.

Upon moving the valve selection mechanism 910 to select the first input port 904, pressurized material flows from source 905a through input port 904 and out of output port 908 as indicated by the direction of the shaded arrows. In response to moving the valve selection mechanism 910, the actuator 914 actuates the first switch 918 to complete a circuit connecting sensor 907a to a display 924. The first sensor 907a senses at least one characteristic associated with the source 905a. In one embodiment, the characteristic may be a pressure level within the source 905a that identifies an amount of material that remains within the source 905a. A data signal representing the sensed characteristic is transmitted from the sensor 907a to the output device 924 for output thereof. The valve selection mechanism 910 may selectively be rotated 180 degrees to select the second source of pressurized material 905b connected to the second port 906. The second sensor 907b may sense the at least one characteristic associated with the source 905b. In response to selecting the second source 905b, the actuator 914 may actuate the second switch 920 completing a circuit connecting the second sensor 907b to the display 924. A data signal representing the sensed characteristic is transmitted from the sensor 907b to the output device 924 for output thereof.

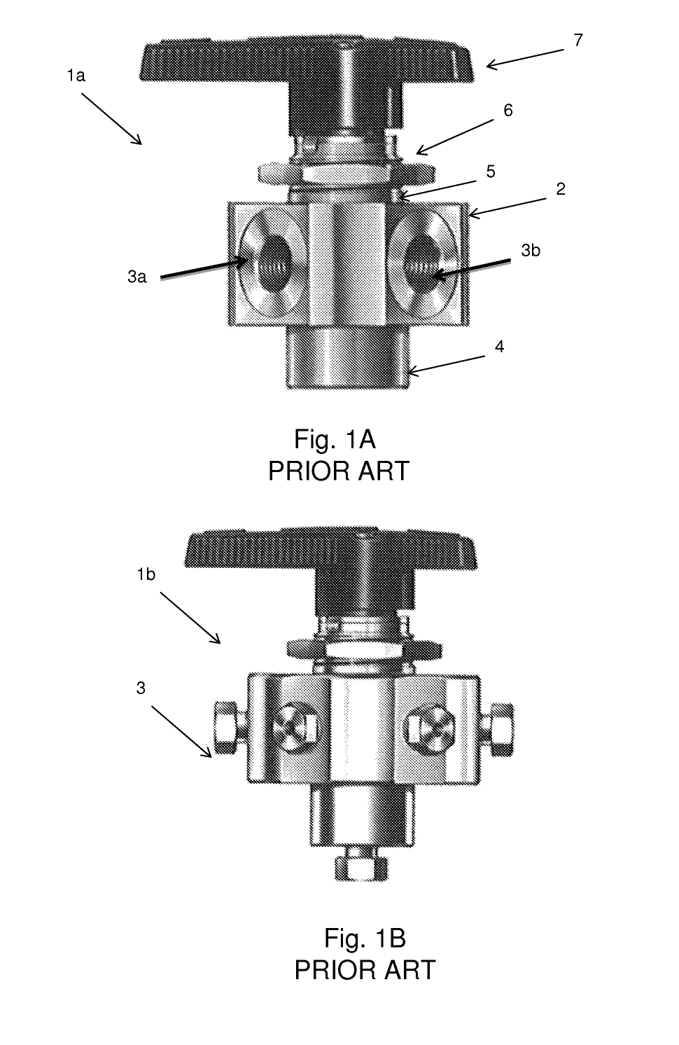

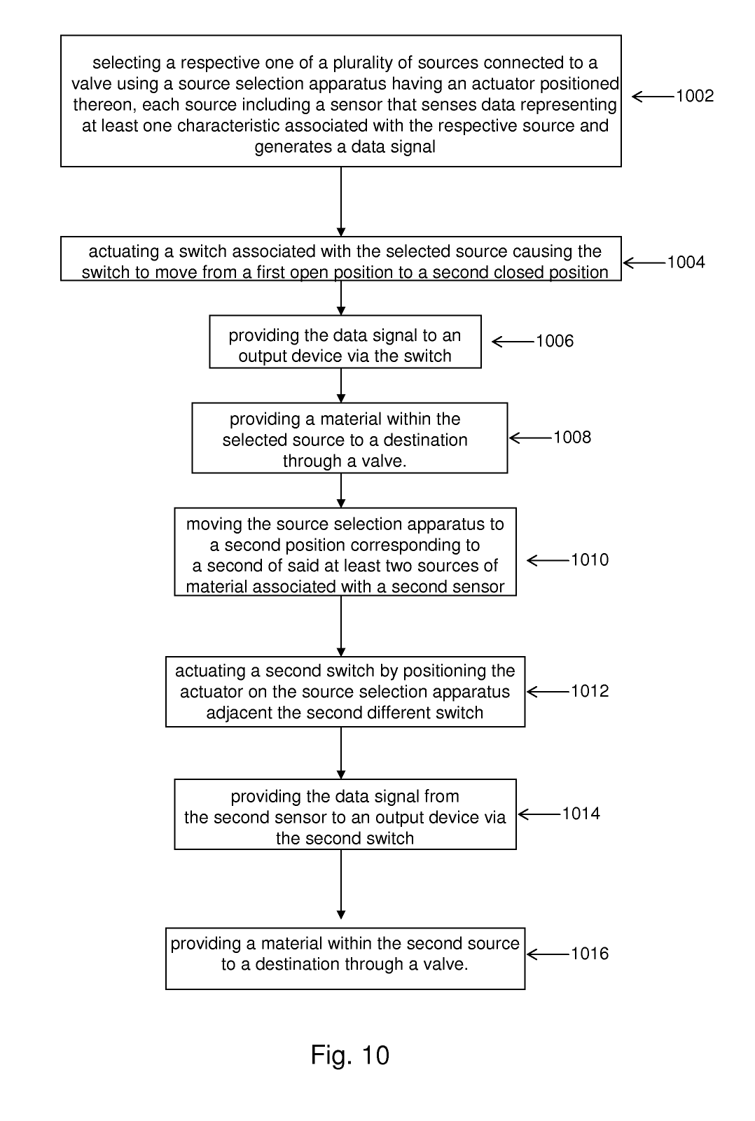

FIG. 10 is a flow diagram detailing an exemplary operation of the electronic valve position indicator described above with respect to FIGS. 1-9. The electronic valve position indicator advantageously selects a source of material from at least two sources of material and provides data associated with the selected source. In step 1002, a respective one of a plurality of sources connected to a valve is selected using a source selection apparatus having an actuator positioned thereon, each source including a sensor that senses data representing at least one characteristic associated with the respective source and generates a data signal. In step 1004, a switch associated with the selected source is actuated causing the switch to move from a first open position to a second closed position. In step 1006, the data signal is provided to an output device via the switch and material within the selected source is provided to a destination through a valve in step 1008. Should the user wish to select a different source of material, the source selection apparatus is moved to a second position corresponding to a second of said at least two sources of material associated with a second sensor in step 1010. A second switch is actuated by positioning the actuator on the source selection apparatus adjacent the second switch in step 1012. The data signal from the second sensor is provided to an output device via the second switch in step 1014 and the material within the second source is provided to a destination through a valve.

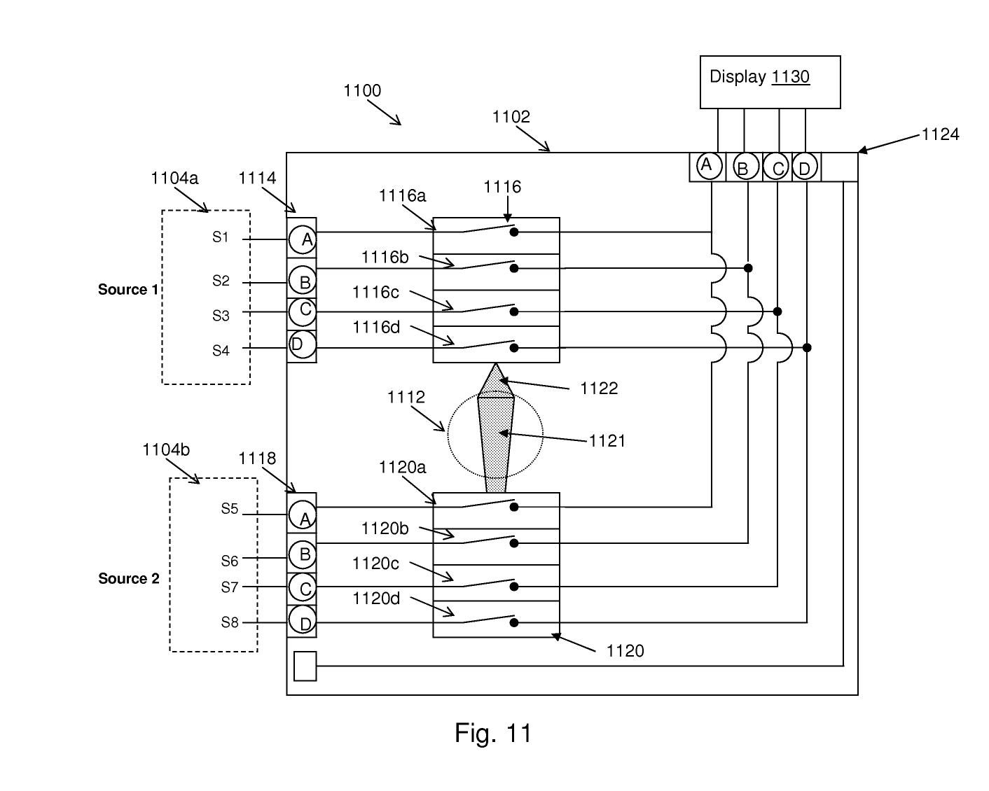

FIG. 11 is a circuit diagram of another exemplary embodiment of the electronic value position indicator according to invention principles. The depiction of this embodiment is not drawn to scale and is for illustrative purposes only to illuminate the principles of the invention. In this embodiment, there are two sources of material denoted as Source 1 and Source 2. Source 1 includes a group of sensors 1104a including sensors S1-S4 that sense or otherwise monitor different characteristics about the material at Source 1. Source 2 includes a group of sensors 1104b including sensors S5-S8 that sense or otherwise monitor different characteristics about the material at the Source 2. The sensors S1-S4 and/or S5-S8 of the respective group of sensors 1104a/1104b may monitor any physical characteristic of the material at the source including but not limited to (a) an amount of pressure (e.g, measured in psi) remaining in the source; (b) a volume level of a liquid at the source; (c) an indicator describing a type of material located at the respective source; (d) a rate at which the material is flowing from the source; (e) an amount of time remaining until the material is depleted from the respective source; (f) PH; (g) Flow; (h) density; (i) temperature; (j) conductance; (k) humidity; and (l) a gas specific sensor (e.g a CO sensor that senses a level of carbon monoxide in Air or Oxygen). Sensors S1-S4 of sources Source 1 and sensors S5-S8 of source 2 are coupled to a circuit board 1102. The circuit board 1102 receives a stem of a valve through aperture 1112. The valve selectively controls the flow of pressurized material from Source 1 and Source 2.

Each sensor in the first group of sensors 1104a is coupled to the circuit board 1102 by a first input block 1114. The input block 1114 includes a plurality of terminals 1114a-1114d. Sensor S1 is coupled to the first input terminal 1114a of the first input block 1114. Sensor S2 is coupled to the second input terminal 1114b of the first input block 1114. Sensor S3 is coupled to the third input terminal 1114c of the first input block 1114. Sensor S4 is coupled to the fourth input terminal 1114d of the first input block 1114. The first input block 1114 is coupled to a first group of switches 1116. The first group of switches 1116 includes four selectively actuatable switches 1116a-1116d. Switches 1116a-11116d are coupled to their respective input terminals 1114a-1114d. Each switch 1116a-1116d of the first group of switches 1116 is coupled to a respective output terminal 1124a-1124d of a common output block 1124.

Each sensor in the second group of sensors 1104b is coupled to the circuit board 1102 by a second input block 1118. The second input block 1118 includes a plurality of terminals 1118a-1118d. Sensor S5 is coupled to the first input terminal 1118a of the second input block 1118. Sensor S6 is coupled to the second input terminal 1118b of the second input block 1118. Sensor S7 is coupled to the third input terminal 1118c of the second input block 1118. Sensor S8 is coupled to the fourth input terminal 1118d of the second input block 1118. The second input block 1118 is coupled to a second group of switches 1120. The second group of switches 1120 includes four selectively actuatable switches 1120a-1120d. Switches 1120a-11206d are coupled to their respective input terminals 1118a-1118d of the second input block 1118. Each switch 1120a-1120d of the second group of switches 1120 is coupled to a respective output terminal 1124a-1124d of a common output block 1124.

The electronic valve position indicator 1100 advantageously automatically outputs data sensed by the sensors S1-S4 of a respective group of sensors 1104a or data sensed by sensors S5-S8 of sensor group 1104b when a valve selection mechanism 1121 having an actuator 1122 is turned to select a valve port that corresponds with either the first group of switches 1116 or the second group of switches 1120 to actuate a respective group of switches and thus complete a circuit. Data representing the sensed characteristics of the material at source 1 is provided from the sensors S1-S4 and data representing the sensed characteristics of the material at source 2 is provided from the sensors S5-S8. When a respective circuit is complete by actuating either the first group of switches 1116 or the second group of switches 1120, sensed data from the selected source is provided to a display 1130. The display device 1130 is connected to the circuit board 1102 via the output block 1124.

Each switch in the first group of switches 1116 and the second group of switches 1120 are maintained in a first open position. When in the first open position the circuit is incomplete. Upon movement of a valve selection mechanism 1121 of the valve, an actuator 1122 is caused to actuate all switches in the selected group of switches 1116/1120 causing them to move from a first open position to a second closed position thereby completing respective circuits. In one embodiment, each switch in the groups of switches 1116 and 1120 may be magnetic reed switches and the actuator 1120 may be a magnet. In this embodiment, the switches 1116/1120 will move from the first open position to the second closed position in response to the positioning of the magnetic actuator 1122 over a respective group of switches. Only switches in the selected group of switches may be in the second closed position at a time thereby ensuring that the data being transmitted across the completed circuit is accurate and only corresponds to the data from a single selected source. In response to a user rotating the valve selection mechanism 1121 of the valve to select a different source, the previously selected switches in the group of switches 1116 or 1120 will move from the second closed position to the first open position thereby breaking the circuit and enabling a newly selected group of switches to move from the first open position to the second closed position thereby completing a circuit an enabling monitoring data with the second source.

Operation of this embodiment is similar to the operation described above with respect to FIGS. 4-10 with the additional advantage that a user may sense and monitor a plurality of different characteristics associated with the material at a respective source of material. Additionally, while each source 1 and source 2 is described having four sensors for sensing four types of characteristic data, one skilled in the art can appreciate that any number of sensors may be implemented for each source. Additionally, the number of sensors employed do not need to be equal such that one source may use a first number of sensors to monitor a first number of different characteristics while a second source may use a different number of sensors to monitor a different number of characteristics. Furthermore, it should be noted that the number of sources of material may be equal to the number of output ports on the valve utilized.

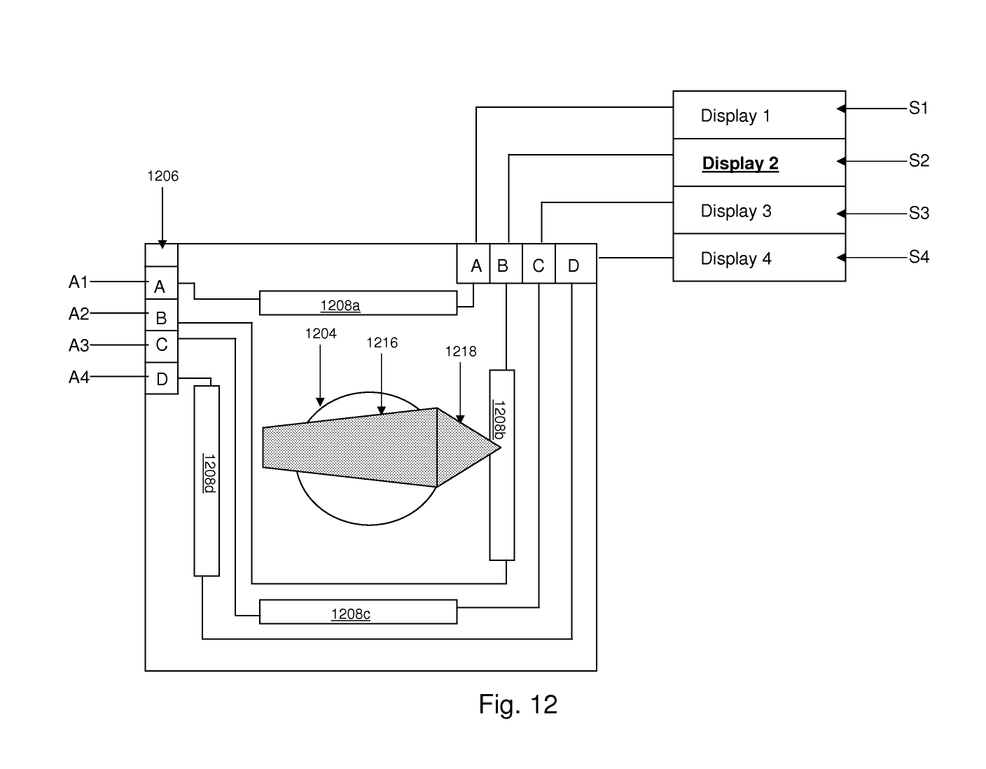

FIG. 12 is an alternate embodiment of the electronic valve position indicator that advantageously provides simultaneous display of sensor data from a plurality of different sources of material while visually differentiating between the data displayed. As shown herein, Sensors S1-S4 are associated with respective sources of pressurized material. These sensors may sense data representing any physical characteristics associated with the respective source of pressurized material. For purposes of example, sensors 1-4 in FIG. 12 are pressure transducers such as described above. The sensors S1-S4 are coupled to a display device 1212 and continuously and simultaneously display data sensed thereby. This embodiment advantageously automatically outputs all data sensed by the sensors S1-S4 simultaneously an output display device 1212 at all times. As shown herein the output display 1212 includes four unique windows 1212a-1212b. However, this is for purpose of example only and the data may be output to individual display devices (e.g. individual LCD screens) or together within a single window in a single display device.

In order to differentiate the data corresponding to a selected source of material, the electronic valve position indicator 1200 includes a plurality of attributes A1-A4. A circuit board 1202 receives a stem of a valve through aperture 1204. The valve selectively controls the flow of pressurized material from a first source denoted with a first attribute (A1), a second source denoted by a second attribute (A2), a third source denoted by a third attribute (A3) and a fourth source denoted by fourth attribute (A4). Attributes A1-A4 are each coupled to the circuit board 1202 at respective terminals 1206a-1206d of an input block 1206. Attribute A1 is connected to an input of the first switch 1208a on the circuit board 1202 via input terminal 1206a. Attribute A2 is connected to an input of the second switch 1208b on the circuit board 1202 via input terminal 1206b. Attribute A3 is connected to an input of the third switch 1208c on the circuit board 1202 via input terminal 1206c. Attribute A4 is connected to an input of the fourth switch 1208d on the circuit board 1202 via input terminal 1206d.

In this embodiment, switches 1208a-1208d are attribute switches that, when activated, apply a voltage representing at least one type of attribute to the display device 1212 via the output block 1210. An output of the first switch 1208a is connected to a portion of display panel 1212a via output terminal 1210a. An output of the second switch 1208b is connected to a portion of display panel 1212b via output terminal 1210b. An output of the third switch 1208c is connected to a portion of display panel 1212c via output terminal 1210c. An output of the fourth switch 1208d is connected to a portion of display panel 1212d via output terminal 1210d. For example, the voltage applied by closing the attribute switch may cause the data from the selected source to appear in a different color than the data from the non-selected sources. Attributes that may be applied to the data include at least one of (a) color; (b) sound and (c) and LED indicator. In the case that the attribute is a sound, each respective source may be associated with a different type/style of sound that is output thereby notifying the user as to which source is currently active. In the case that the attribute is an LED indicator, the indicator may be different for each source. Alternatively, the attribute applied to the data may be different at different times. In one embodiment, the data is modified with a first attribute when the source is selected and, upon sensing that the material in the source is below a threshold value (e.g. pressure falls below a threshold psi), a second different attribute may be applied to the signal to further differentiate the data. For example, if the first attribute may be a color and the second attribute may be blinking text.

The operation of the switches and valve selection mechanism shown herein are similar to those described above. However, when the switches associated with a selected source is caused to move from the first open position to the second closed position, a voltage corresponding to a type of attribute that is associated with the selected source is applied to the display panel associated with the selected source in order to display that data on the display device 1212 in a visually distinct manner than the data sensed sensors associated with non-selected sources.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus comprising:
a valve including
at least two input ports, a first of the at least two input ports connected to a first source of material and a second of said at least two input ports connected to a second source of material;
an output port; and
a valve selector for selectively connecting one of the at least two input ports to the output port;
an electric circuit that selectively connects an output device to receive data from:
a first sensor associated with the first source of material that senses at least one characteristic associated with the first source of material when said valve selector is in a first position connecting the first of the two input ports to the output port, and
a second sensor associated with a second source of material that senses at least one characteristic associated with the second source of material when the valve selector is in a second position connecting the second of the two input ports to the output port.

2. The apparatus according to claim 1, further comprising
a power source connected between the output device and the first and second sensors that that provides power to
the first sensor when said valve selector is in the first position, and
the second sensor when said valve selector is in the second position.

3. The apparatus according to claim 1, further comprising
an actuator positioned on the valve selector; and wherein said electric circuit further includes
a first switch connected between the first sensor and the output device; and
a second switch connected between the second sensor and the output device, wherein
in response selecting the first input port, the actuator is moved to a position causing the first switch to close and complete a circuit enabling transmission of a data signal including data representing the sensed at least one characteristic for output on the output device; and
in response selecting the second input port, the actuator is moved to a position causing the second switch to close and complete a circuit enabling transmission of a data signal including data representing the sensed at least one characteristic for output on the output device.

4. The apparatus according to claim 3, wherein
Said valve includes a plurality of input ports; and
said electrical circuit includes a plurality of switches, each of the plurality of switches having a corresponding input port on said valve.

5. The apparatus according to claim 3, wherein said first switch is substantially aligned with the first input port of the valve and the second switch is substantially aligned with the second input port of the valve.

6. The apparatus according to claim 1, wherein
said output device is a display screen that displays data from at least one of the first sensor and the second sensor.

7. The apparatus according to claim 1, wherein
said the output device includes at least one of (a) a display screen; (b) a wearable display device; (c) a gauge; (d) a computerized monitoring system; (e) a database; and (f) a communication device that transmits a signal over a wired or wireless communication network.

8. The apparatus according to claim 1, wherein
said at least one characteristic sensed represents an amount of pressure within a source.

9. The apparatus according to claim 1, where
said at least one characteristic sensed includes at least one of (a) an amount of pressure (psi) within a respective source; (b) a volume level of a liquid within a respective source; (c) a type of material within a respective source; (d) a rate at which the material is flowing from the respective source and (e) an amount of time remaining until the material is depleted from within a respective source.

10. The apparatus according to claim 1, wherein
in response to said valve selector being in said first position, said first sensor continuously provides data representing the at least one characteristic associated with the first source to the output device, and
in response to said valve selector being in said second position, said second sensor continuously provides data representing the at least one characteristic associated with the second source to the output device.

11. A method of selecting a source of material from at least two sources of material and providing data associated with the selected source comprising the activities of:
selecting a respective one of a plurality of sources connected to a valve using a source selection apparatus having an actuator positioned thereon, each source including a sensor that senses data representing at least one characteristic associated with the respective source and generates a data signal;
actuating a switch associated with the selected source causing the switch to move from a first open position to a second closed position;
providing the data signal to an output device via the switch; and
providing a material within the selected source to a destination through a valve.

12. The method according to claim 11, further comprising the activity of
moving the source selection apparatus to a second position corresponding to a second of said at least two sources of material associated with a second sensor; and
actuating a second switch by positioning the actuator on the source selection apparatus adjacent the second different switch; and
providing the data signal from the second sensor to an output device via the second switch; and
providing a material within the second source to a destination through a valve.

13. The method according to claim 11, wherein
the output device includes at least one of (a) a display screen; (b) a wearable display device; (c) a gauge; (d) a computerized monitoring system; (e) a database; and (f) a communication device that transmits a signal over a wired or wireless communication network.

14. The method according to claim 11, wherein
the at least one characteristic sensed by the sensor includes at least one of (a) an amount of pressure (psi) within a respective source; (b) a volume level of a liquid within a respective source; (c) a type of material within a respective source; (d) a rate at which the material is flowing from the respective source and (e) an amount of time remaining until the material is depleted from within a respective source.
